(19) United States
(12) Patent Application Publication
(10) Pub. No.: US 2019/0312274 A1
(43) Pub. Date: Oct. 10, 2019

(54) POSITIVE ELECTRODE ACTIVE MATERIAL AND NONAQUEOUS ELECTROLYTE SECONDARY BATTERY

(71) Applicant: PANASONIC INTELLECTUAL PROPERTY MANAGEMENT CO., LTD., Osaka-shi, Osaka (JP)

(72) Inventors: Akihiro KAWAKITA, Hyogo (JP); Takeshi OGASAWARA, Hyogo (JP)

(73) Assignee: Panasonic Intellectual Property Management Co., Ltd., Osaka-shi, Osaka (JP)

(21) Appl. No.: 16/309,039

(22) PCT Filed: Jun. 7, 2017
(86) PCT No.: PCT/JP2017/021084

§ 371 Date: Dec. 11, 2018

(30) Foreign Application Priority Data
Jun. 30, 2016 (JP) 2016-130153

(51) Int. Cl. H01M 4/525; H01M 10/05; H01M 4/131

(52) U.S. Cl. CPC H01M 4/525; H01M 2004/021; H01M 4/131; H01M 10/05

(57) ABSTRACT

A positive electrode active material according to an embodiment includes secondary particles each formed of aggregated primary particles of a lithium transition metal oxide containing 80 mol % or more of nickel, based on a total molar amount of a metal element other than lithium. The positive electrode active material further includes a rare earth compound attached to each surface of the secondary particles and one or more lithium compounds attached to each surface of the primary particles inside the secondary particles. The lithium compounds include lithium hydroxide.

### TECHNICAL FIELD

The present disclosure relates to a positive electrode active material and a nonaqueous electrolyte secondary battery.

### BACKGROUND ART

Patent Literature 1 (PTL 1) discloses a positive electrode active material in which a Group 3 element in the periodic table exists on the surface of a lithium transition metal oxide. In addition, Patent Literature 2 (PTL 2) discloses a lithium transition metal oxide that includes a surface portion where at least one selected from Al, Ti, and Zr exists on a particle surface and that has an amount of surface LiOH of less than 0.1 wt % and an amount of surface Li₂CO₃ of less than 0.25 wt %.

### CITATION LIST

### Patent Literature

PTL 1: International Publication No. 2005/008812

PTL 2: International Publication No. 2016/035852

### SUMMARY OF INVENTION

Improving high-temperature storage characteristics is an important object of a high-capacity nonaqueous electrolyte secondary battery including a high nickel-content positive electrode active material. PTL 1 discloses that a positive electrode active material having undiminished battery performance even after storage in a charged state can be provided. However, there is still room for improvement in conventional techniques, such as techniques for the positive electrode active material of PTL 1.

A positive electrode active material according to an embodiment of the present disclosure is a positive electrode active material for a nonaqueous electrolyte secondary battery, the active material including secondary particles each formed of aggregated primary particles of a lithium transition metal oxide containing 80 mol % or more of nickel, based on a total molar amount of a metal element other than lithium, where: the positive electrode active material further includes a rare earth compound attached to each surface of the secondary particles and one or more lithium compounds attached to each surface of the primary particles inside the secondary particles; and the lithium compounds include lithium hydroxide. The content of lithium hydroxide is 0.05 mass % or more based on the mass of the lithium transition metal oxide.

A nonaqueous electrolyte secondary battery according to another embodiment of the present disclosure includes a positive electrode containing the above-described positive electrode active material, a negative electrode, and a nonaqueous electrolyte.

A positive electrode active material according to an embodiment of the present disclosure can improve high-temperature storage characteristics of a nonaqueous electrolyte secondary battery.

### BRIEF DESCRIPTION OF DRAWINGS

FIG. 1 is a cross-sectional view of a nonaqueous electrolyte secondary battery according to an embodiment.

FIG. 2 is a cross-sectional view of a positive electrode active material particle according to another embodiment.

FIG. 3A is a cross-sectional view of a positive electrode active material particle used in Comparative Example 1.

FIG. 3B is a cross-sectional view of a positive electrode active material particle used in Comparative Example 2.

FIG. 3C is a cross-sectional view of a positive electrode active material particle used in Comparative Example 3.

### DESCRIPTION OF EMBODIMENTS

The present inventors found that deterioration in battery characteristics after high-temperature storage in a charged state is significantly suppressed by attaching a rare earth compound to each surface of secondary particles of high nickel-content lithium transition metal oxide and by attaching a lithium compound (lithium hydroxide) to each surface of primary particles inside the secondary particles. Such an effect can be specifically achieved only when both a rare earth compound and a lithium compound exist.

In a nonaqueous electrolyte secondary battery including a positive electrode active material according to an embodiment of the present disclosure, it is believed that a protective coating having excellent lithium ion permeability is formed on the active material surface in contact with a nonaqueous electrolyte due to a synergistic effect of the rare earth compound and the lithium compound. When a conventional positive electrode active material is used, it is assumed that the battery capacity decreases during high-temperature storage in a charged state due to, for example, progress in decomposition of the lithium compound or oxidation of nickel in the lithium transition metal oxide. Meanwhile, when a positive electrode active material according to an embodiment of the present disclosure is used, it is believed that the above-mentioned protective coating suppresses decomposition of the lithium compound, oxidation of nickel, and the like, thereby ensuring a high capacity even after high-temperature storage.

Hereinafter, embodiments will be described in detail with reference to the drawings. However, a positive electrode active material and a nonaqueous electrolyte secondary battery of the present disclosure are not limited to the embodiments described hereinafter. In an embodiment below, a cylindrical battery in which an electrode assembly of a rolled configuration is held in a cylindrical battery case will be described as an example. The electrode assembly, however, is not limited to a rolled configuration and may be a stacked configuration in which a plurality of positive electrodes and a plurality of negative electrodes are alternately stacked via separators. Moreover, the battery case is not limited to a cylindrical shape and may be a metal case of a prismatic shape (prismatic battery), a coin shape (coin battery), or the like; or a resin case composed of resin films (laminate battery). The drawings, which are referred to in the description of embodiments, are schematically shown, and thus the size and the like of each component should be determined by taking into account the description hereinafter.

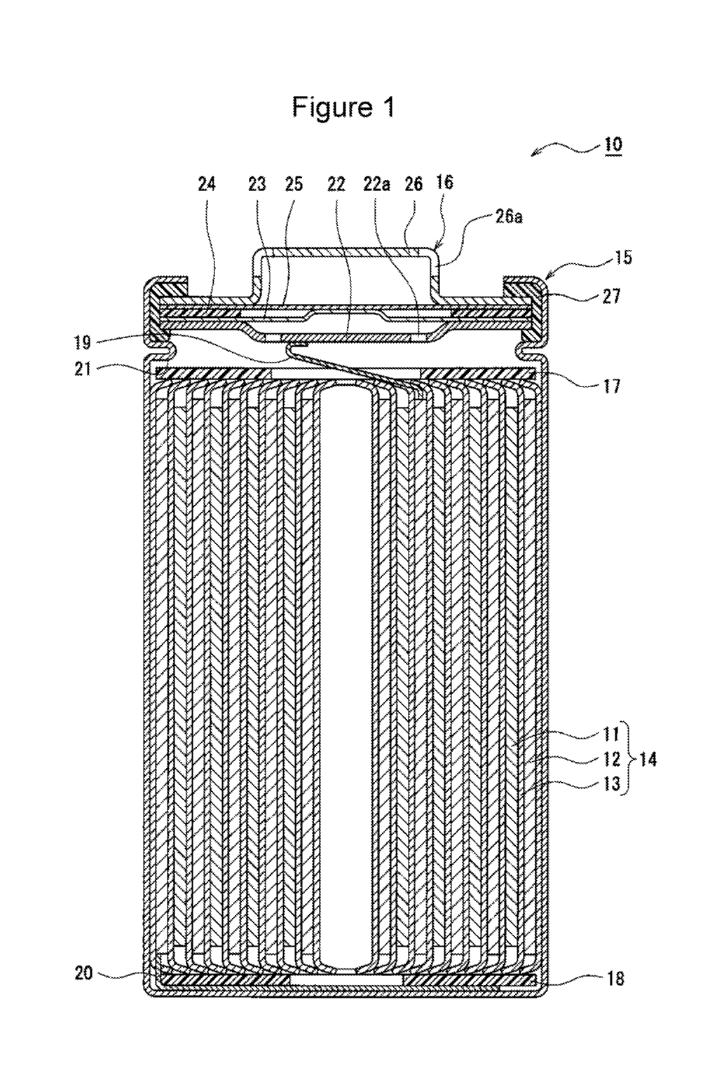

FIG. 1 is a cross-sectional view of a nonaqueous electrolyte secondary battery 10 according to an embodiment. As illustrated in FIG. 1, the nonaqueous electrolyte secondary battery 10 includes an electrode assembly 14, a nonaqueous electrolyte (not shown), and a battery case that holds the electrode assembly 14 and the nonaqueous electrolyte. The electrode assembly 14 has a rolled configuration in which a positive electrode 11 and a negative electrode 12 are rolled via a separator 13. The battery case is composed of a flat-bottomed cylindrical case body 15 and a seal 16 that covers an opening of the case body.

The nonaqueous electrolyte secondary battery 10 includes insulating plates 17 and 18 arranged above and below the electrode assembly 14, respectively. In the example illustrated in FIG. 1, a positive electrode lead 19 attached to the positive electrode 11 extends to the side of the seal 16 via a through hole of the insulating plate 17, whereas a negative electrode lead 20 attached to the negative electrode 12 extends to the bottom side of the case body 15 via the outside of the insulating plate 18. The positive electrode lead 19 is connected to a lower surface of a filter 22, which is a bottom plate of the seal 16, by welding or the like, and thus a cap 26, which is a top plate of the seal 16 electrically connected to the filter 22, constitutes a positive electrode terminal. Meanwhile, the negative electrode lead 20 is connected to the bottom inner surface of the case body 15 by welding or the like, and thus the case body 15 constitutes a negative electrode terminal.

The case body 15 is a flat-bottomed cylindrical metallic container, for example. A gasket 27 is provided between the case body 15 and the seal 16, thereby ensuring sealing of the inside of the battery case. The case body 15 has an overhang 21 that is formed, for example, by pressing the side surface portion from the outside and that supports the seal 16. The overhang 21 is preferably formed annularly in the circumferential direction of the case body 15 and supports the seal 16 by using its upper surface.

The seal 16 includes the filter 22 and a valve arranged thereabove. The valve closes the opening 22a of the filter 22 and breaks when internal pressure of the battery rises due to heat generated by an internal short circuit or the like. In the example illustrated in FIG. 1, a lower valve 23 and an upper valve 25 are provided as valves, and an insulator 24 is arranged between the lower valve 23 and the upper valve 25. Each component of the seal 16 has, for example, a disk shape or a ring shape, and such components other than the insulator 24 are electrically connected to each other. When internal pressure of the battery rises significantly, for example, the lower valve 23 breaks at its thin portion, and consequently the upper valve 25 swells to the side of the cap 26 and moves apart from the lower valve 23, thereby terminating electrical connections between the lower valve 23 and the upper valve 25. When internal pressure rises further, the upper valve 25 breaks to release gas from an opening 26a of the cap 26.

Hereinafter, each component, especially a positive electrode active material, of the nonaqueous electrolyte secondary battery 10 will be described in detail.

[Positive Electrode]

The positive electrode 11 is composed of a positive electrode current collector, such as a metal foil, and a positive electrode active material layer formed on the positive electrode current collector. For the positive electrode current collector, a metal foil of aluminum or the like, which is stable in the potential range of the positive electrode 11, or a film having such metal as a surface layer may be used, for example. A positive electrode mixture layer contains a positive electrode active material, a conductive material, and a binder. The positive electrode 11 can be fabricated, for example, by applying a positive electrode mixture slurry containing a positive electrode active material, a conductive material, a binder, and the like onto a positive electrode current collector, drying the resulting coatings, and then rolling, thereby forming positive electrode mixture layers on both sides of the current collector.

Examples of the conductive material include carbon materials, such as carbon black, acetylene black, Ketjen black, and graphite. The carbon materials may be used alone or in a combination of two or more.

Examples of the binder include fluoro resins, such as polytetrafluoroethylene (PTFE) and polyvinylidene fluoride (PVdF); polyacrylonitrile (PAN); polyimides; acrylic resins; and polyolefins. In addition, these resins may be used together with carboxymethyl cellulose (CMC), a salt thereof, or polyethylene oxide (PEO), for example. These may be used alone or in a combination of two or more.

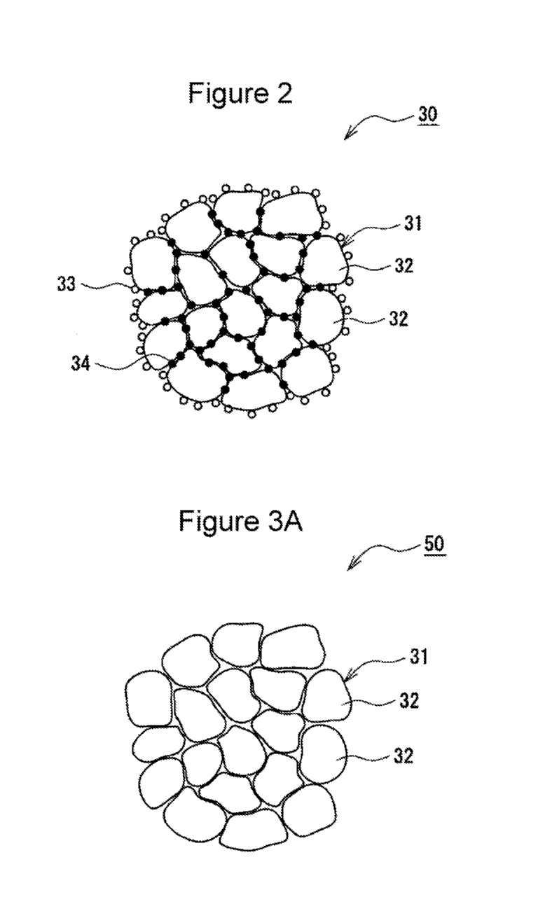

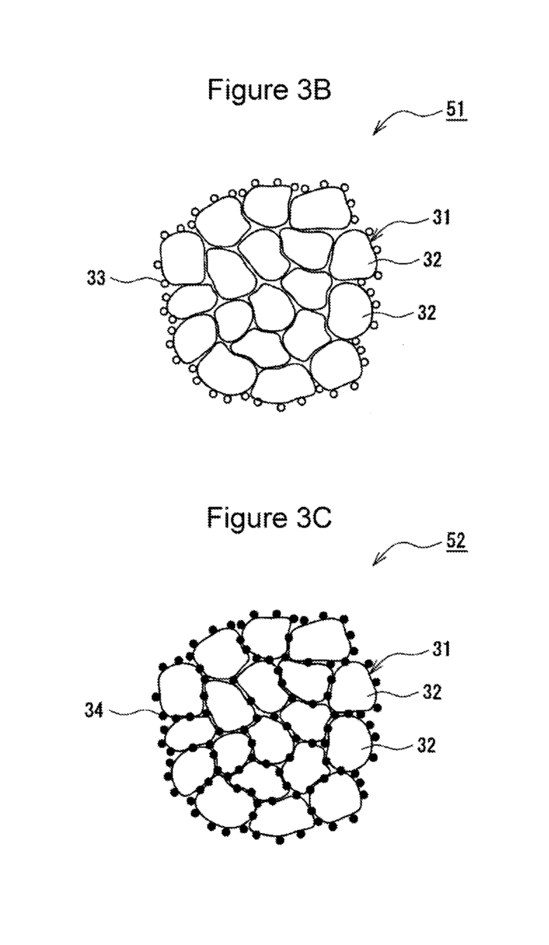

FIG. 2 is a cross-sectional view of a positive electrode active material 30 for a nonaqueous electrolyte secondary battery according to the embodiment. As illustrated in FIG. 3, the positive electrode active material 30 includes a secondary particle 31 formed of aggregated primary particles 32 of a lithium transition metal oxide. The positive electrode active material 30 further includes a rare earth compound 33 attached to the surface of the secondary particle 31 and a lithium compound 34 attached to each surface of the primary particles 31 inside the secondary particle 31. This means that the positive electrode active material 30 is composed of particles each containing the lithium transition metal oxide, the rare earth compound, and the lithium compound.

The particle size of the positive electrode active material 30 is determined by the particle size of the secondary particle 31 of the lithium transition metal oxide. The particle size of the rare earth compound 33 attached to the surface of the secondary particle 31 is considerably small compared with the particle size of the secondary particle 31. Accordingly, the particle size of the positive electrode active material 30 and the particle size of the secondary particle 31 are substantially the same. An average particle size of the secondary particle 31 is, for example, 2 μm to 30 μm or 5 μm to 20 μm. The average particle size of the secondary particle 31 herein refers to a median diameter (volume-based) determined by a laser diffraction method and can be measured by using, for example, a laser diffraction/scattering-type particle size distribution analyzer from HORIBA, Ltd.

The particle size of the primary particles 32 that constitute the secondary particle 31 is, for example, 100 nm to 5 μm or 300 nm to 2 μm. The particle size of each primary particle 32 herein refers to a diameter of a circumcircle of the primary particle 32 in a SEM image obtained through observation of the cross-section of the secondary particle 31 under a scanning electron microscope (SEM). A BET specific surface area of the positive electrode active material 30 is, for example, 0.05 m²/g to 0.9 m²/g and preferably 0.1 m²/g to 0.6 m/g. When the BET specific surface area is within this range, high-temperature storage characteristics are readily improved. The BET specific surface area of the positive electrode active material 30 can be determined by using an automatic surface area and porosity analyzer (TriStar II 3020) from Shimadzu Corporation, for example.

The lithium transition metal oxide contains 80 mol % or more of nickel (Ni), based on a total molar amount of a metal element other than lithium (Li). By increasing the Ni content in the lithium transition metal oxide, a high capacity of a positive electrode can be achieved. The Ni content may be 0.85 mol % or more. The lithium transition metal oxide is an oxide represented, for example, by a composition formula of LiₐNiₓM₍₁₋ₓ₎O₂ (0.95≤a≤1.2, 0.8≤x<1.0, M is a metal element other than Li and Ni).

The metal element other than Li and Ni, which is contained in the lithium transition metal oxide, is at least one selected from magnesium (Mg), aluminum (Al), calcium (Ca), scandium (Sc), titanium (Ti), vanadium (V), chromium (Cr), manganese (Mn), iron (Fe), cobalt (Co), copper (Cu), zinc (Zn), gallium (Ga), germanium (Ge), yttrium (Y), zirconium (Zr), tin (Sn), antimony (Sb), lead (Pb), and bismuth (Bi), for example. Among these metal elements, at least one selected from Co, Mn, and Al is preferably contained.

As described above, the rare earth compound 33 has a smaller particle size than the secondary particle 31 of the lithium transition metal oxide and is attached to the surface of the secondary particle 31. The rare earth compound 33 is preferably attached to the surface of the secondary particle 31 uniformly without localization on the surface of the secondary particle 31. The rare earth compound 33 is, for example, strongly bonded to the surface of the secondary particle 31. Examples of the rare earth compound 33 include a hydroxide, an oxyhydroxide, an oxide, a carbonate, a phosphate, and a fluoride of a rare earth element.

The rare earth compound 33 contains at least one selected from Sc, Y, lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). Among these elements, at least one selected from Nd, Sm, and Er is preferred. Compounds of Nd, Sm, and Er improve high-temperature storage characteristics more effectively than other rare earth compounds.

Specific examples of the rare earth compound 33 include a hydroxide, such as neodymium hydroxide, samarium hydroxide, or erbium hydroxide; an oxyhydroxide, such as neodymium oxyhydroxide, samarium oxyhydroxide, or erbium oxyhydroxide; a phosphate, such as neodymium phosphate, samarium phosphate, or erbium phosphate; a carbonate, such as neodymium carbonate, samarium carbonate, or erbium carbonate; an oxide, such as neodymium oxide, samarium oxide, or erbium oxide; and a fluoride, such and neodymium fluoride, samarium fluoride, or erbium fluoride.

The rare earth compound 33 exists in a proportion, on a rare earth element basis, of preferably 0.02 mass % to 0.5 mass % and more preferably 0.03 mass % to 0.2 mass % based on the mass of the lithium transition metal oxide. When the amount of the rare earth compound 33 attached to the surface of the secondary particle 31 is within the above range, high-temperature storage characteristics can be improved efficiently while ensuring a high capacity of a positive electrode. The amount of the rare earth compound 33 attached is determined by ICP atomic emission spectroscopy.

The particle size of the rare earth compound 33 is, for example, 5 nm to 100 nm or 5 nm to 80 nm. The particle size of the primary particles 32 herein refers to a diameter of a circumcircle of the rare earth compound 33 in a SEM image of the surface of the secondary particle 31. Further, an average particle size of the rare earth compound 33 is, for example, 20 nm to 60 nm. The average particle size of the rare earth compound 33 is calculated by averaging particle sizes (N=100) of the rare earth compound 33 obtained through the above-described SEM observation.

As described above, the lithium compound 34 has a smaller particle size than the secondary particle 31 of the lithium transition metal oxide and is attached to each surface of the primary particles 32 inside the secondary particle 31. The lithium compound 34 is preferably uniformly attached to each surface of the primary particles 32 that are located inside the secondary particle 31. The lithium compound 34 is, for example, strongly bonded to each surface of the primary particles 32.

One or more lithium compounds 34 include at least lithium hydroxide (LiOH). The lithium compounds 34 may include a lithium compound other than LiOH.

The content of lithium hydroxide is 0.05 mass % or more and preferably 0.2 mass % or more based on the mass of the lithium transition metal oxide. A suitable range of the lithium hydroxide content is, for example, 0.1 mass % to 0.5 mass % or 0.2 mass % to 0.3 mass %. When the amount of the lithium compound 34 attached to each surface of the primary particles 32 inside the secondary particle 31 is within the above range, high-temperature storage characteristics can be improved efficiently while ensuring a high capacity of a positive electrode. The amount of the lithium compound 34 attached can be determined by titration.

The amount of the lithium compound 34 attached per unit area of the secondary particle 31 surface is smaller than the amount of the lithium compound 34 attached per unit area of the primary particle 32 surface inside the secondary particle 31. The lithium compound 34 preferably exists substantially solely inside the secondary particle 31 without existing on the surface of the secondary particle 31.

The positive electrode active material 30 is manufactured, for example, through a step A of synthesizing the lithium transition metal oxide (secondary particle 31) and a step B of attaching the rare earth compound 33 to the surface of the secondary particle 31. In the step B, the rare earth compound 33 is attached to the surface of the secondary particle 31, for example, by spraying onto the secondary particle 31 an aqueous dispersion in which the rare earth compound 33 is dispersed in a water-based aqueous medium or an aqueous solution in which the rare earth compound 33 is dissolved in an aqueous medium.

In the step A, the secondary particle 31 of the lithium transition metal oxide is prepared, for example, by synthesizing a Ni transition metal oxide through coprecipitation, followed by mixing the resulting oxide with a lithium compound and calcining the mixture. Examples of the Ni transition metal oxide include a complex oxide containing at least one selected from Ni, Co, Mn, and Al. The lithium compound is, for example, lithium hydroxide (LiOH). The calcination is performed, for example, at a temperature of 700° C. to 900° C. under a stream of oxygen.

Since some Li is lost due to evaporation during calcination, excessive Li (lithium compound) relative to the intended stoichiometric ratio of a product is used. Consequently, one or more lithium compounds 34 including LiOH exist on each surface of the primary particles 32 that constitute the secondary particle 31.

In the step B, an aqueous dispersion or an aqueous solution of the rare earth compound 33 is sprayed onto the secondary particle 31, and the secondary particle 31 to which the rare earth compound 33 has been attached is then dried. For the aqueous solution of the rare earth compound 33, an aqueous solution containing a rare earth metal acetate, nitrate, sulfate, or hydrochloride, for example, is used. The concentration of such a rare earth metal salt in an aqueous solution is, for example, 0.01 g/ml to 0.1 g/ml on a rare earth element basis.

In the step B, the secondary particle 31 obtained in the step A is used in an unwashed state, i.e., without washing with water. Accordingly, one or more lithium compounds 34 including LiOH remain attached to each surface of the primary particles 32 inside the secondary particle 31. Meanwhile, LiOH that has been attached to the surface of the secondary particle 31 is neutralized by an aqueous solution of the rare earth compound 33. Consequently, the lithium compounds 34 become substantially absent from the surface of the secondary particles 31.

The secondary particle 31 to whose surface the rare earth compound 33 has been attached is preferably dried at a lower temperature than the calcination temperature in the step A. Drying or vacuum drying is performed, for example, at a temperature of 150° C. to 300° C. By drying the secondary particle 31 to whose surface the rare earth compound 33 has been attached, the rare earth compound 33 becomes strongly attached (bonded) to the surface of the secondary particle 31.

Since water washing is not performed in the step B, LiOH attached to the secondary particle 31 is not dissolved. When water washing of the secondary particle 31 is not performed after the step A, a positive electrode active material having a specific surface area of 0.9 m²/g or less and preferably 0.6 m²/g or less and an amount of LiOH attached to the positive electrode active material of 0.05 mass % or more, preferably 0.1 mass % or more, and more preferably 0.2 mass % or more based on the mass of the lithium transition metal oxide can be obtained. Meanwhile, when water washing of the secondary particle 31 is performed after the step A, LiOH that has been attached to the secondary particle 31 is dissolved, thereby increasing a BET specific surface area and decreasing the amount of LiOH.

[Negative Electrode]

A negative electrode 12 is composed of, for example, a negative electrode current collector, such as a metal foil, and a negative electrode mixture layer formed on the current collector. For the negative electrode current collector, a metal foil of copper or the like, which is stable in the potential range of the negative electrode 12, and a film having such metal arranged as a surface layer, for example, may be used. The negative electrode mixture layer contains a negative electrode active material and a binder. The negative electrode 12 can be fabricated, for example, by applying a negative electrode mixture slurry containing a negative electrode active material, a binder, and the like onto the negative electrode current collector, drying the resulting coatings, and then rolling, thereby forming negative electrode mixture layers on both sides of the current collector.

The negative electrode active material is not particularly limited provided that lithium ions can be adsorbed and desorbed reversibly. Examples of the negative electrode active material include a carbon material, such as natural graphite or artificial graphite; metal that forms an alloy with lithium, such as silicon (Si) or tin (Sn); and an alloy or a complex oxide containing a metal element, such as Si, Sn, or the like. The negative electrode active material may be used alone or in a combination of two or more.

As the binder, fluoro resins, PAN, polyimides, acrylic resins, and polyolefins, for example, may be used as in the case of the positive electrode. When the mixture slurry is prepared by using an aqueous solvent, CMC or a salt thereof, styrene-butadiene rubber (SBR), polyacrylic acid (PAA) or a salt thereof, or polyvinyl alcohol (PVA), for example, is preferably used.

[Separator]

As a separator 13, an ion-permeable insulating porous sheet is used. Specific examples of the porous sheet include a microporous membrane, a woven fabric, and a nonwoven fabric. The separator 13 is formed of, for example, a polyolefin, such as polyethylene or polypropylene, or cellulose. The separator 13 may be a layered structure including a cellulose fiber layer and a thermoplastic resin fiber layer made of a polyolefin or the like. Alternatively, the separator 13 may be a multilayer separator including a polyethylene layer and a polypropylene layer or may include a surface layer formed of an aramid or a surface layer containing inorganic filler.

[Nonaqueous Electrolyte]

A nonaqueous electrolyte contains a nonaqueous solvent and a solute (electrolyte salt) dissolved in the nonaqueous solvent. Examples of the nonaqueous solvent include esters; ethers; nitriles; amides, such as dimethylformamide; isocyanates, such as hexamethylene diisocyanate; and mixed solvents of two or more thereof. The nonaqueous solvents may include halogenated solvents, in which hydrogen of the above-mentioned solvents is at least partially replaced with halogen atoms, such as fluorine.

Examples of the esters include cyclic carbonate esters, such as ethylene carbonate (EC), propylene carbonate (PC), and butylene carbonate; linear carbonate esters, such as dimethyl carbonate (DMC), methyl ethyl carbonate (EMC), diethyl carbonate (DEC), methyl propyl carbonate, ethyl propyl carbonate, and methyl isopropyl carbonate; cyclic carboxylic acid esters, such as γ-butyrolactone and γ-valerolactone; and linear carboxylic acid esters, such as methyl acetate, ethyl acetate, propyl acetate, methyl propionate (MP), and ethyl propionate.

Examples of the ethers include cyclic ethers, such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol, and crown ethers; and linear ethers, such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles include acetonitrile, propionitrile, butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile.

Examples of the halogenated solvents include fluorinated cyclic carbonate esters, such as fluoroethylene carbonate (FEC); fluorinated linear carbonate esters; and fluorinated linear carboxylic acid esters, such as methyl fluoropropionate (FMP).

Examples of the electrolyte salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (1<x<6; n=1, 2), LiB₁₀Cl₁₀, LiCl, LiBr, LiI, chloroborane lithium complex, a lower aliphatic carboxylic acid lithium salt, borates, such as Li₂B₄O₇ and Li(B(C₂O₄)F₂), and imide salts, such as LiN(SO₂CF₃)₂ and LiN(C₁F₂ₗ₊₁SO₂) (CₘF₂ₘ₊₁SO₂) (l and m are each independently an integer of one or more). The electrolyte salt may be used alone or in combination. The concentration of the electrolyte salt is, for example, 0.8 to 1.8 mol/L-nonaqueous solvent.

### EXAMPLES

Hereinafter, the present disclosure will be further described with the Examples. The present disclosure, however, is not limited to the Examples.

### Example 1

[Fabrication of Positive Electrode Active Material]

A lithium transition metal oxide represented as LiNi_{0.91}Co_{0.06}Al_{0.03}O₂ was synthesized by mixing nickel cobalt aluminum oxide having a Ni:Co:Al composition ratio of 91:6:3 with lithium hydroxide (LiOH) at a molar ratio of 1:1.03 and calcining the resulting mixture under a stream of oxygen at 750° C. for 3 hours. The obtained lithium transition metal oxide was pulverized to yield secondary particles A1 of the lithium transition metal oxide having a median diameter (volume-based) of 10 μm. The median diameter of the secondary particles A1 was determined by using a LA-920 laser diffraction/scattering-type particle size distribution analyzer from HORIBA, Ltd.

Next, an aqueous solution containing, on Er basis, 0.03 g/ml of erbium sulfate was sprayed on unwashed secondary particles A1 to attach erbium hydroxide to each surface of the secondary particles A1. The secondary particles A1, to whose surface erbium hydroxide had been attached, were dried at 200° C. for 2 hours to yield a positive electrode active material A1 composed of the secondary particles A1, to whose surface erbium hydroxide was attached. The amount of erbium hydroxide attached was determined by inductively coupled plasma (ICP) ionization to be 0.11 mass % based on the mass of the secondary particle A1. The amount of lithium hydroxide attached was determined by titration (Warder's method) according to the equation below to be 0.22 mass % based on the mass of the secondary particle A1. Further, a BET specific surface area was 0.35 m²/g.

Titration (Warder's method): A suspension in which active material powders were dispersed in pure water was prepared by adding active material powders to pure water and stirring. The suspension was then filtered to yield a filtrate containing an alkali dissolved from the active material.

Hydrochloric acid was added in small portions to the filtrate while pH was measured, and the amount of lithium hydroxide attached was calculated by using the equation below from the amounts of hydrochloric acid consumed up to the first inflection point (near pH 8) and the second inflection point (near pH 4) of the pH curve.

Equation: amount of lithium hydroxide (wt %)=(x (mL)−(y (mL)−x (mL)))×a (mol/L)×f×( 1/1000)×23.95 (g/mol))/b (g)×100

hydrochloric acid concentration used for titration: a (mol/L)

amount of sample taken: b (g)

amount of hydrochloric acid consumed up to first

inflection point (near pH 8): x (mL)

amount of hydrochloric acid consumed up to second inflection point (near pH 4): y (mL)

factor of hydrochloric acid used for titration: f

lithium hydroxide: F.W.=23.95 (g/mol)

[Fabrication of Positive Electrode]

A positive electrode mixture slurry was prepared by mixing the above-described positive electrode active material, acetylene black, and polyvinylidene fluoride at a mass ratio of 100:1.25:1 and adjusting the viscosity by adding an appropriate amount of N-methyl-2-pyrrolidone (NMP). Subsequently, the positive electrode mixture slurry was applied to both sides of a positive electrode current collector formed of an aluminum foil. The resulting coatings were dried and then rolled with a roller, and an aluminum current collector tab was fixed to the current collector. A positive electrode in which positive electrode mixture layers were formed on both sides of the positive electrode current collector was thus fabricated.

[Fabrication of Negative Electrode]

A negative electrode mixture slurry was prepared by mixing graphite powders, styrene-butadiene rubber (SBR), and carboxymethyl cellulose sodium salt at a mass ratio of 100:1:1 and adjusting the viscosity by adding an appropriate amount of water. Subsequently, the negative electrode mixture slurry was uniformly applied to both sides of a negative electrode current collector formed of a copper foil. The resulting coatings were then dried and rolled with a roller, and a nickel current collector tab was fixed to the current collector. A negative electrode in which negative electrode mixture layers were formed on both sides of the negative electrode current collector was thus fabricated.

[Preparation of Nonaqueous Electrolyte Solution]

A nonaqueous electrolyte was prepared by mixing ethylene carbonate (EC), methyl ethyl carbonate (MEC), and dimethyl carbonate (DMC) at a volume ratio of 2:2:6, dissolving lithium hexafluorophosphate (LiPF₆) at a concentration of 1.3 mol/L in the resulting mixed solvent, and then further dissolving vinylene carbonate (VC) at a concentration of 2.0 mass % in the mixed solvent.

[Fabrication of Battery]

A flat-shaped rolled electrode assembly was prepared by spirally rolling the above-described positive electrode and negative electrode via a separator and then compressing the rolled body. A battery A1 was fabricated by inserting the electrode assembly into a case formed of an aluminum laminated sheet, feeding the above-described nonaqueous electrolyte into the case, and then sealing the case.

The battery A1 was subjected to a high-temperature storage test, and the evaluation results are shown in Table 1 (The same applies to the Examples and Comparative Examples hereinafter).

[High-Temperature Storage Test]

At room temperature, the battery A1 was subjected to constant-current charging at 1 C to 4.2 V and then constant-voltage charging at 4.2 V to a current value of about 0.05 C to complete charging. After a rest for 10 minutes, the battery A1 was subjected to constant-current discharging at 1 C to 2.5 V. From the discharge curve for this step, a discharge capacity was obtained and set as a capacity before storage. After a rest for 5 minutes, the battery A1 was subjected to constant-current discharging at 0.05 C to 2.5 V.

After a rest for 10 minutes, one cycle of the above-described charging was performed, and the battery A1 in a charged state was stored in a thermostatic chamber at 85° C. for 3 hours. Subsequently, the temperature of the battery A1 was lowered to room temperature, and the battery A1 was subjected to the above-described discharging. A discharge capacity (capacity after storage) was obtained from the discharge curve at a discharge rate of 1 C.

A capacity retention rate of the battery A1 after the high-temperature storage test was calculated according to the following equation.

Capacity retention rate (%)=(capacity after storage/capacity before storage)×100

### Example 2

A battery A2 was fabricated in a similar manner to Example 1 except for changing the concentration of the erbium sulfate aqueous solution and the amount of erbium sulfate sprayed onto the secondary particles A1, thereby changing the amount of erbium hydroxide attached to the surface of the secondary particle A1 to 0.02 mass %.

### Example 3

A battery A3 was fabricated in a similar manner to Example 1 except for changing the concentration of the erbium sulfate aqueous solution and the amount of erbium sulfate sprayed onto the secondary particles A1, thereby changing the amount of erbium hydroxide attached to the surface of the secondary particle A1 to 0.33 mass %.

### Example 4

A battery A4 was fabricated in a similar manner to Example 1 except for using neodymium sulfate in place of erbium sulfate, thereby attaching neodymium hydroxide to the surface of the secondary particle A1. In this example, the amount of neodymium hydroxide attached was determined by ICP to be 0.095 mass % based on the mass of the secondary particle A1.

### Example 5

A battery A5 was fabricated in a similar manner to Example 1 except for using samarium sulfate in place of erbium sulfate, thereby attaching samarium hydroxide to the surface of the secondary particle A1. In this example, the amount of samarium hydroxide attached was determined by ICP to be 0.1 mass % based on the mass of the secondary particle A1.

### Comparative Example 1

A battery B1 was fabricated in a similar manner to Example 1 except for using a positive electrode active material (hereinafter, referred to as a positive electrode active material 50) that had been prepared by washing the secondary particles A1 of the lithium transition metal oxide with water, filtering, and drying at 200° C. for 2 hours. The positive electrode active material 50 had an amount of LiOH attached, which was determined by titration, of 0.02 mass % based on the mass of the secondary particle and a BET specific surface area of 0.95 m²/g.

As illustrated in FIG. 3A, the positive electrode active material 50 is composed of secondary particles 31 each formed of aggregated primary particles 32 of the lithium transition metal oxide. On the respective surfaces of the secondary particle 31 and the primary particles 32, a rare earth compound is absent, and the lithium compound is almost absent.

### Comparative Example 2

A battery B2 was fabricated in a similar manner to Example 1 except for using a positive electrode active material (hereinafter, referred to as a positive electrode active material 51) that had been prepared by washing the secondary particles A1 of the lithium transition metal oxide with water, filtering, then spraying onto the secondary particles an aqueous solution of erbium sulfate, which was the same as that used in Example 1, and drying the secondary particles, to whose surface erbium hydroxide had been attached, at 200° C. for 2 hours. The positive electrode active material 51 had an amount of LiOH attached, which was determined by titration, of 0.02 mass % based on the mass of the secondary particle and a BET specific surface area of 0.97 m²/g.

As illustrated in FIG. 3B, the positive electrode active material 51 includes secondary particles 31 each formed of aggregated primary particles 32 of the lithium transition metal oxide, as well as the rare earth compound 33 attached to the surface of the secondary particle 31. Meanwhile, the lithium compound is almost absent from the respective surfaces of the secondary particle 31 and the primary particles 32 inside the secondary particle 31.

### Comparative Example 3

A battery B3 was fabricated in a similar manner to Example 1 except for using the secondary particles A1 of the lithium transition metal oxide without further processing as a positive electrode active material (hereinafter, referred to as a positive electrode active material 52). The positive electrode active material 52 had an amount of LiOH attached, which was determined by titration, of 0.44 mass % based on the mass of the secondary particle and a BET specific surface area of 0.26 mZ/g.

As illustrated in FIG. 3C, the positive electrode active material 52 includes secondary particles 31 each formed of aggregated primary particles 32 of the lithium transition metal oxide, as well as the lithium compound 34 (LiOH) attached to the respective surfaces of the secondary particle 31 and the primary particles 32 inside the secondary particle 31. Meanwhile, a rare earth compound is absent on the surface of the secondary particle 31.

TABLE 1

| | Positive electrode active material | | | Battery |
|---|---|---|---|---|
| | Rare earth | | | Capacity |
| | compound | LiOH | | retention rate |
| | [mass %] | [mass %] | BET (m²/g) | [%] |
| Example 1 | 0.11 | 0.22 | 0.35 | 98.3 |
| Example 2 | 0.02 | 0.42 | 0.31 | 98.1 |
| Example 3 | 0.33 | 0.21 | 0.37 | 98.1 |
| Example 4 | 0.095 | 0.23 | 0.35 | 98.2 |
| Example 5 | 0.099 | 0.21 | 0.35 | 98.3 |
| Comparative | — | 0.02 | 0.95 | 97.6 |
| Example 1 | | | | |
| Comparative | 0.11 | 0.02 | 0.97 | 97.8 |
| Example 2 | | | | |
| Comparative | — | 0.44 | 0.26 | 97.1 |
| Example 3 | | | | |

As shown in Table 1, all the batteries of the Examples have a higher capacity retention rate than the batteries of the Comparative Examples, as well as excellent high-temperature storage characteristics. In other words, high-temperature storage characteristics are specifically improved only when a rare earth compound exists on the surface of each secondary particle of the lithium transition metal oxide at 0.05 mass % or more based on the mass of the lithium transition metal oxide, and LiOH exists on each surface of primary particles inside the secondary particle.

In each battery of Comparative Examples 1 and 2, a BET specific surface area of the positive electrode active material was larger than 0.9 m²/g and an amount of LiOH attached to the positive electrode active material was 0.02 mass % or less. Thus, in each battery of Comparative Examples 1 and 2, a BET specific surface area of the positive electrode active material is larger than those of other batteries, and little LiOH attached to the positive electrode active material exists. This is because LiOH attached to the inside and the surface of each secondary particle A1 of the lithium transition metal oxide was dissolved during water washing of the secondary particle 31 (A1).

### INDUSTRIAL APPLICABILITY

The present invention is applicable to positive electrode active materials and nonaqueous electrolyte secondary batteries.

### REFERENCE SIGNS LIST

10 Nonaqueous electrolyte secondary battery
11 Positive electrode
12 Negative electrode
13 Separator
14 Electrode assembly
15 Case body
16 Seal
17, 18 Insulating plate
19 Positive electrode lead
20 Negative electrode lead
21 Overhang
22 Filter
22a Opening
23 Lower valve
24 Insulator
25 Upper valve
26 Cap
26a Opening
27 Gasket
30 Positive electrode active material
31 Secondary particle of lithium transition metal oxide (secondary particle)
32 Primary particle of lithium transition metal oxide (primary particle)
33 Rare earth compound
34 Lithium compound

1. A positive electrode active material for a nonaqueous electrolyte secondary battery, comprising secondary particles each formed of aggregated primary particles of a lithium transition metal oxide containing 80 mol % or more of nickel, based on a total molar amount of a metal element other than lithium, wherein: the positive electrode active material further comprises
a rare earth compound attached to each surface of the secondary particles and
one or more lithium compounds attached to each surface of the primary particles inside the secondary particles;
the lithium compounds include lithium hydroxide; and
the content of lithium hydroxide is 0.05 mass % or more based on the mass of the lithium transition metal oxide.

2. The positive electrode active material according to claim 1, wherein the rare earth compound exists in a proportion, on a rare earth element basis, of 0.02 mass % to 0.5 mass % based on the mass of the lithium transition metal oxide.

3. The positive electrode active material according to claim 1, wherein:
a BET specific surface area is 0.1 m²/g to 0.6 m²/g; and
the content of lithium hydroxide is 0.2 mass % or more based on the mass of the lithium transition metal oxide.

4. The positive electrode active material according to claim 1, wherein the rare earth compound contains at least one selected from neodymium, samarium, and erbium.

5. A nonaqueous electrolyte secondary battery comprising:
a positive electrode containing the positive electrode active material according to claim 1;
a negative electrode; and
a nonaqueous electrolyte.
